(19) United States
(12) Patent Application Publication
(10) Pub. No.: US 2003/0232241 A1
(43) Pub. Date: Dec. 18, 2003

(54) Electrochemical element

(75) Inventors: Thomas Woehrle, Ellwangen (DE); Peter Birke, Ellwangen (DE); Fatima Birke-Salam, Ellwangen (DE); Claudia Rathmann, Ellwangen (DE); Stefan Fuerst, Schwabsberg (DE); Heinrich Stelzig, Rosenberg (DE); Dejan Ilic, Ellwangen (DE)

Correspondence Address: IP DEPARTMENT OF PIPER RUDNICK LLP, 3400 TWO LOGAN SQUARE, 18TH AND ARCH STREETS, PHILADELPHIA, PA, 19103, US

(73) Assignee: VARTA Microbattery GmbH, a corporation of Germany, Hannover (DE)

(21) Appl. No.: 10/457,109

(22) Filed: Jun. 9, 2003

(30) Foreign Application Priority Data
Jun. 15, 2002 (DE) 102 26 848.7

(51) Int. Cl. H01M 2/02; H01M 2/08

(52) U.S. Cl. 429/127; 429/162; 429/175

(57) ABSTRACT

An electrochemical element has at least one lithium-intercalating electrode and a thin flexible housing composed of two metal sheets, which rest directly on the electrodes and are connected to one another in a sealing manner via an adhesive or sealing layer. At least one of the metal sheets is provided on the outside with a plastic layer, which increases the robustness and strength. An adhesion layer is arranged between the metal sheet and the plastic layer. The metal sheet is composed, for example, of copper. The plastic layer is composed, for example, of polyimide. The adhesion layer is based, for example, on rubber.

### RELATED APPLICATION

This application claims priority of German Patent Application No. 102 26 848.7, filed Jun. 15, 2002.

### FIELD OF THE INVENTION

This invention relates to an electrochemical element, in particular, having at least one lithium-intercalating electrode and a thin, flexible housing composed of two metal sheets which rest directly on the electrodes and are sealingly connected to one another via an adhesive or sealing layer.

### BACKGROUND

Extremely thin, flexible electrochemical elements with a total thickness of less than 0.5 mm are required, for example, as energy stores in active smart cards. In the case of thin electronic smart cards such as these, the flat energy store is intended to provide the electrical power supply for the IC chip and for other components such as integrated miniature sensors or transponders.

Such a thin and flexible electrochemical element is suitable for installation in active smart cards, since bending tests and test procedures can be complied with. During a dynamic bending test, the card is curved through 2 cm in length or 1 cm in width at a frequency of 30 bends per minute (=0.5 Hz). During this test, a card must withstand at least 250 bends in each of the four possible directions (that is to say a total of 1000 bends) without damage. During the dynamic torsion test, the card is loaded through ±15° about the longitudinal axis at a frequency of 30 bends per minute (=0.5 Hz). The Standard demands 1000 torsions without the chip functionality failing and without any mechanical damage being visible on the card.

High mechanical forces occur during these tests, in particular, on the metallic outer housing of the electrochemical element. In the process, a pure metal housing for the element may tear, with the cell being opened. In this case, the entire system, that is to say the card together with the electrochemical element or battery, is then, obviously, unusable.

EP 997 959 B1 describes an electrochemical element having a non-aqueous electrolyte, and a housing composed of laminate films. Such laminates are generally composed of a composite aluminum sheet coated on both sides, can easily be thermoformed down to 5 mm, and passes the test by virtue of this characteristic. The plastic sheathing in this case prevents tearing.

DE 101 02 125 describes the mechanical reinforcement of an electronic smart card with an electrochemical element arranged in it by means of a partial or entire cover composed of metal or fiber-reinforced plastic.

It would, therefore, be advantageous to provide an electrochemical element which satisfies the stringent requirements for mechanical robustness when subjected to bending loads and torsion loads, for use in an active smart card.

### SUMMARY OF THE INVENTION

This invention relates to an electrochemical element including a thin, flexible housing and at least one electrode, wherein the housing includes at least two metal sheets sealingly connected to one another, and positioned directly adjacent the at least one electrode, wherein a plastic layer is provided on an outer portion of at least one of the metal sheets.

### BRIEF DESCRIPTION OF THE DRAWINGS

FIG. 1 is a schematic perspective view of a flat cell in accordance with aspects of the invention.

FIG. 2 is a partial cross section taken through the flat cell of FIG. 1, along the line A-A.

### DETAILED DESCRIPTION

It will be appreciated that the following description is intended to refer to specific embodiments of the invention selected for illustration in the drawings and is not intended to define or limit the invention, other than in the appended claims.

The electrochemical elements according to EP 997 959 B1 are based on relatively thick laminates, namely about 100 μm. Since the inside also has an insulating plastic layer, an assembly in which the internal plastic sheet is omitted is sufficient for this invention. This ensures direct contact with the negative electrode and positive electrode.

Surprisingly, it has been found that even a thin plastic layer or plastic sheet applied on one side, namely on the side of the metal sheet which points or is oriented outwardly, results in a very considerable reinforcing effect with respect to torsion and bending. A sheet assembly such as this, according to aspects of the invention, comprises a metal sheet and a plastic layer or a plastic film and, possibly, an adhesion layer. Examples of suitable plastics are polyethylene terephthalate (PET), polyethylene naphthalate (PEN), polyvinylidene chloride (PVC), polyimide (PI) or the like.

A distinction is drawn between three main types for the adhesion layer. Adhesion layers based on rubber allow reversible bonding. Adhesion layers based on acrylic acid may be adhesion layers which still have to be subsequently polymerized or sealed. These result in irreversible bonding. Adhesion layers based on silicone or polysiloxane are generally mixtures of silicone and rubber. Their excellent characteristics are generally good robustness at high temperature, little aging and the possibility to apply them two or more times, associated with repeated removal without any residue. The last-mentioned type is particularly highly suitable for subsequent application in the form of labels. Adhesion layers based on polysiloxane and applied to polyvinylidene chloride (PVC) are known under the trade name “Tesa” from Beiersdorf. The already mentioned polyethylene terephthalate may also be used instead of PVC and PI. Typical adhesion layer thicknesses are about 12 μm-about 15 μm, and, technically, they vary between about 8 μm and about 25 μm.

Stainless steel, bimetallic elements (nickel/stainless steel) or trimetallic elements (nickel/stainless steel/copper) are typical representatives for the metal sheet. The outer nickel layer in the case of a bimetallic or trimetallic element is, thus, advantageously used to make electrical contact with the load. An inner copper layer may be advantageous, both for contacting with the cell interior and for electrochemical reasons.

The excellent characteristics of copper of the metal sheet satisfy a large number of requirements. It can easily be rolled down to thicknesses of about 10 μm, is very much easier to make contact with than stainless steel in the area of the outer output conductors, and the hardness or softness can be adjusted by rolling and annealing. All these processes can be carried out at low cost. Furthermore, copper has a sufficient electrochemical stability window for many electrochemical elements. Various copper alloys such as copper/magnesium alloy can also be used instead of copper.

The metal sheet may have a thickness of about 8 μm to about 55 μm, preferably of about 18 μm to about 35 μm. The plastic layer may have a thickness of about 8 μm to about 40 μm, preferably of about 10 μm to about 20 μm. The adhesion layer may have a thickness of about 1 μm to about 25 μm, preferably of about 5 μm to about 15 μm.

The electrode may be a lithium-intercolating electrode, but need not be. It is advantageous to provide at least one of the metal sheets on the inside pointing toward the electrode with a layer of electrochemically deposited metal to improve adhesion. A metal sheet with an adhesion-improving layer is disclosed in U.S. patent application Ser. No. 10/327,255, the subject matter of which is incorporated herein by reference.

By way of example, a composite system which is already permanently coated or bonded and is composed of a metal sheet, in particular, of a copper sheet and a plastic film, may be used, for example, to produce the housing for an electrochemical element according to aspects of the invention. The semi-finished products used for the electrochemical element, namely the cell cover and the cell cup, are manufactured from this composite material. Outside the area of the electrodes, they are laminated with sealing films used to bond the cell cover and cell cup in a sealing manner.

It is also possible to cover the metallic housing of the electrochemical element on at least one of the two outer faces, for example, with siliconized adhesive tapes such as siliconized polyimide tape or polyester tape. Adhesive tapes such as these adhere to metal sheets self-adhesively and substantially permanently.

Electrochemical elements having a composite sheet according to the invention as the housing have better robustness and strength: in addition to the already mentioned mechanical protection during the bending tests, the electrochemical element has high resistance to penetration and additional thermal protection for the electrochemically active cell interior during hot lamination. The element housing is insulated except for the area of the small free zone for the output conductor, thus, considerably reducing the risk of an inadvertent external short circuit. The area around the output conductors is additionally stabilized. Possible microholes or cracks in the metal sheet are covered, and the cell is effectively protected against damaging water, oxygen or carbon dioxide diffusion.

These and further measures are also evident from the claims and from the description and the drawings, in which case the individual features may each be implemented on their own or in conjunction with one another in the form of subcombinations for one embodiment of the invention and in other fields and may represent advantageous embodiments, which are patentable in their own right, for which protection is claimed here.

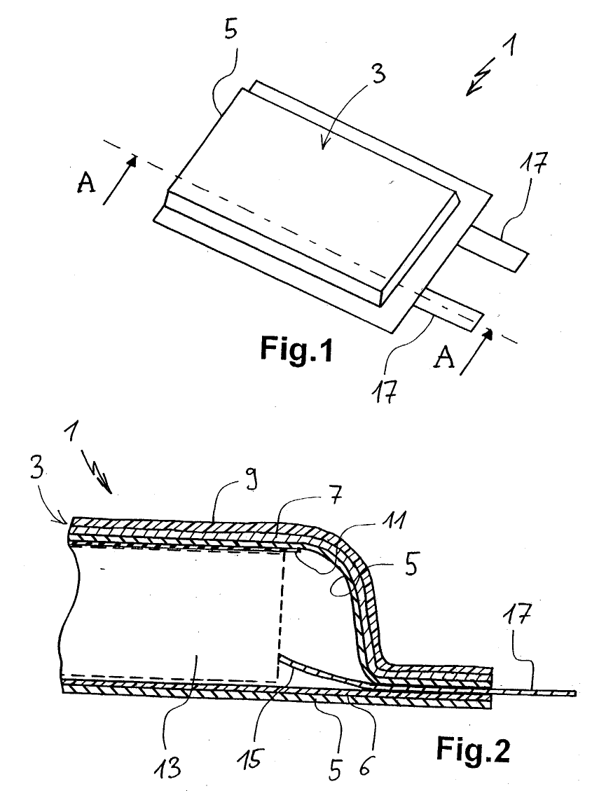

The subject matter of the invention will be explained in more detail in the following text with reference to FIGS. 1 and 2.

The flat cell 1 contains one or more individual cells in a thin, flexible housing 3 composed of metal sheets 5. The metal sheets 5 are provided on the outside of the cell 1 with a plastic layer 9 to improve robustness. The plastic layer 9 is in the form of a capton tape, that is applied to the upper face of the housing 3 by an adhesive layer 7. The upper metal sheet 5 is provided with a metal layer 11 on the side facing the interior of the flat cell 1. The lower metal sheet 5 has insulation 6 on the inside.

As illustrated schematically by the dashed lines, an individual cell 13 is located inside the cell 1 and may be formed from a positive electrode and a negative electrode. The individual cell 13 has schematically illustrated connections 15 to respective output lugs 17.

An example of the production of an element as described above:

A pasty compound is produced by using 77 percent by weight of manganite (electrolytic manganese dioxide) which is thermally activated at 360° C., 6 percent by weight of graphite, 2 percent by weight of conductive carbon black, 7 percent by weight of polyvinylidene difluoride hexafluoropropylene and 8 percent by weight of propylene carbonate, mixed thoroughly in acetone. The resulting compound is wiped onto a polyolefin separator (polypropylene) and the carrier solvent is vaporized. The resulting tape is dried in a vacuum (110° C. for 48 hours) and impregnated with an organic lithium electrolyte whose composition is 0.96 M LiClO₄ in 87:13% by volume of propylene carbonate to ethyl methyl carbonate. The separator/electrode composite pieces are stamped out to a size of 1.6×2.3 cm², and inserted into a copper sheet housing.

Lithium is pressed in advance onto the side of the cover. This cup side is, if required, also provided with an electrochemically deposited copper crystallite layer, with a conductivity improver based on graphite. In the areas in which copper meets copper between the cup and the cover, an insulation layer (sealing layer) is in each case provided, and ultrasound welding is carried out. Electrochemical cells according to the invention produced in this way are suitable for incorporation in active smart cards, and pass the bending test and the test procedure.

In a first embodiment, the copper sheet that is used is already provided with a tape of capton before processing to form the housing parts. In a second refinement, the complete cells were subsequently bonded using a capton tape (polyimide base) or Tesa tape. This adhesive tape is applied to both sides of the complete housing using an unrolling method.

1. An electrochemical element comprising a thin, flexible housing and at least one electrode, wherein the housing comprises at least two metal sheets sealingly connected to one another, and positioned directly adjacent at least one electrode, wherein a plastic layer is provided on an outer portion of at least one of the metal sheets.

2. The electrochemical element as claimed in claim 1, wherein the metal sheets are connected to one another with an adhesive layer or a sealing layer.

3. The electrochemical element as claimed in claim 1, wherein an adhesion layer is arranged between the metal sheet and the plastic layer.

4. The electrochemical element as claimed in claim 1, wherein at least one of the metal sheets comprises copper.

5. The electrochemical element as claimed in claim 1, wherein at least one of the metal sheets comprises stainless steel.

6. The electrochemical element as claimed in claim 1, wherein the plastic layer is formed from a material selected from the group consisting of polyethylene terephthalate, polyethylene naphthalate, polyvinylidene chloride and polyimide.

7. The electrochemical element as claimed in claim 3, wherein the adhesion layer is based on a material selected from the group consisting of rubber, acrylic acid, polysiloxane and silicone.

8. The electrochemical element as claimed in claim 1, wherein at least one of the metal sheets is provided with a metal layer on an inside portion of the housing oriented toward the electrode.

9. The electrochemical element as claimed in claim 1, wherein the metal sheet has a thickness of about 8 μm to about 55 μm.

10. The electrochemical element as claimed in claim 1, wherein the plastic layer has a thickness of about 8 μm to about 40 μm.

11. The electrochemical element as claimed in claim 3, wherein the adhesion layer has a thickness of about 1 μm to about 25 μm.

12. The electrochemical element as claimed in claim 1, wherein the electrode is a lithium-intercalating electrode.
